(19) United States
(12) Patent Application Publication
(10) Pub. No.: US 2008/0143635 A1
(43) Pub. Date: Jun. 19, 2008

(54) Retainer for Retaining a Coaxial Cable on a Planar Antenna

(76) Inventors: Sheng-Chih Lin, Taipei (TW); Tsung-Wen Chiu, Taipei (TW); Fu-Ren Hsiao, Taipei (TW)

Correspondence Address: FROMMER LAWRENCE & HAUG, 745 FIFTH AVENUE- 10TH FL., NEW YORK, NY, 10151, US

(21) Appl. No.: 11/955,054

(22) Filed: Dec. 12, 2007

(30) Foreign Application Priority Data
Dec. 15, 2006 (TW) 095147096

(51) Int. Cl. H01Q 1/50; H01R 9/00

(52) U.S. Cl. 343/906; 439/585

(57) ABSTRACT

A retainer is adapted for retaining a coaxial cable on a planar antenna. The coaxial cable includes a core conductor disposed at the center thereof, an insulator provided around the core conductor, an outer conductor provided around the insulator, and an insulating sheath provided around the outer conductor. The retainer is metallic, and includes a clamping member including a C-shaped clamp for clamping and contacting electrically the outer conductor of the coaxial cable, and a connecting member connected integrally to the clamping member and adapted to be connected electrically to the planar antenna.

### CROSS-REFERENCE TO RELATED APPLICATION

This application claims priority of Taiwanese Application No. 095147096, filed on Dec. 15, 2006.

### BACKGROUND OF THE INVENTION

1. Field of the Invention

The invention relates to a retainer, more particularly to a retainer for retaining a coaxial cable on a planar antenna.

2. Description of the Related Art

In a conventional antenna device, a coaxial cable is connected directly and electrically to an antenna structure by soldering. However, with the use of leadless solder having a high melting point of about 400° C. a longer processing period is needed for soldering a coaxial cable to an antenna structure as a result of the high melting point of the leadless solder.

Furthermore, heat generated during the longer processing period may damage an insulator and an insulating sheath of the coaxial cable, thereby resulting in adverse influence on the coaxial cable.

### SUMMARY OF THE INVENTION

Therefore, the object of the present invention is to provide a retainer for retaining a coaxial cable on a planar antenna that can overcome the aforesaid drawbacks of the prior art.

According to one aspect of the present invention, a retainer for retaining a coaxial cable on a planar antenna is provided. The coaxial cable includes a core conductor disposed at the center thereof, an insulator provided around the core conductor, an outer conductor provided around the insulator, and an insulating sheath provided around the outer conductor. The retainer is metallic and comprises:

a clamping member including a C-shaped first clamp adapted for clamping the outer conductor of the coaxial cable such that the first clamp is adapted to contact electrically the outer conductor of the coaxial cable; and

a connecting member connected integrally to the clamping member and adapted to be connected electrically to the planar antenna.

According to another aspect of the present invention, an antenna device comprises:

a planar antenna including
a substrate having a first surface provided with a ground pattern and a conductor pattern thereon, and a second surface opposite to the first surface;

a coaxial cable including a core conductor disposed at the center thereof, an insulator provided around the core conductor, an outer conductor provided around the insulator, and an insulating sheath provided around the outer conductor; and

a retainer made of a metal material and including
a clamping member including a C-shaped first clamp for clamping the outer conductor of the coaxial cable such that the first clamp contacts electrically the outer conductor of the coaxial cable, and
a connecting member connected integrally to the clamping member and connected electrically to the ground pattern of the substrate of the planar antenna.

### BRIEF DESCRIPTION OF THE DRAWINGS

Other features and advantages of the present invention will be come apparent in the following detailed description of the preferred embodiments with reference to the accompanying drawings, of which:

FIG. 1 is a partly exploded perspective view showing an antenna device according to a first preferred embodiment of the present invention;

FIG. 2 is an enlarged exploded perspective view showing a retainer and a coaxial cable of the first preferred embodiment;

FIG. 3 is a fragmentary schematic side view showing the first preferred embodiment;

FIG. 4 is a fragmentary schematic side view showing an antenna device according to a second preferred embodiment of the present invention; and

FIG. 5 is a fragmentary schematic rear view showing an antenna device according to a third preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

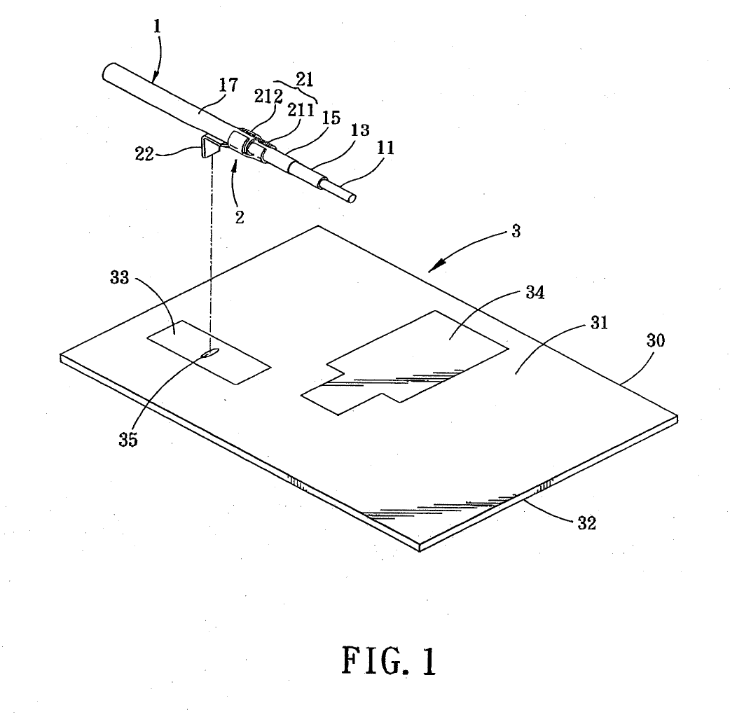

Referring to FIGS. 1 to 3, an antenna device according to a first preferred embodiment of the present invention is shown to include a planar antenna 3, a coaxial cable 1, and a retainer 2.

The planar antenna 3 includes a substrate 30 that has a first surface 31 provided with a ground pattern 33 and a conductor pattern 34 thereon, and a second surface 32 opposite to the first surface 31. In this embodiment, the ground pattern 33 and the conductor pattern 34 are spaced apart from each other. The substrate 30 is formed with a through hole 35 extending from the first surface 31 to the second surface 32.

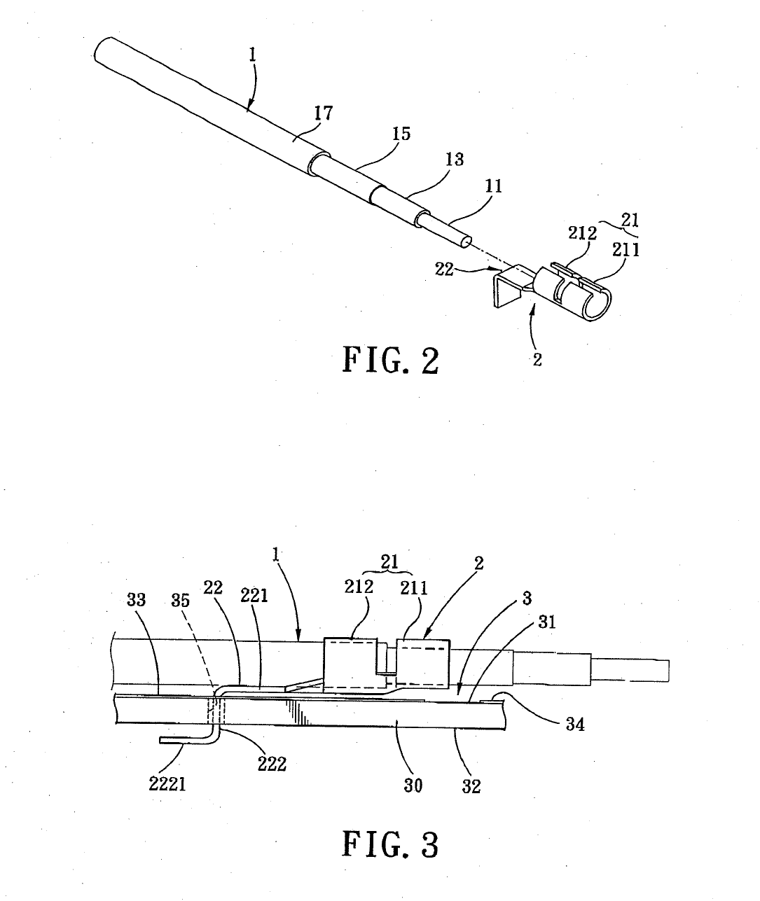

The coaxial cable 1 includes a core conductor 11 disposed at the center thereof, an insulator 13 provided around the core conductor 11, an outer conductor 15 provided around the insulator 13, and an insulating sheath 17 provided around the outer conductor 15, as best shown in FIG. 2.

The retainer 2 is made of a metal material, and includes a clamping member 21 and a connecting member 22. In this embodiment, the clamping member 21 includes C-shaped first and second clamps 211, 212, wherein the first clamp 211 clamps the outer conductor 15 of the coaxial cable 1 such that the first clamp 211 contacts electrically the outer conductor 15 of the coaxial cable 1, and the second clamp 212 clamps the insulating sheath 17 of the coaxial cable 1. The connecting member 22 is connected integrally to the clamp member 21 and is connected electrically to the ground pattern 33 of the substrate 30 of the planar antenna 3. In this embodiment, the connecting member 22 is in the form of an inverted L-shaped plate that has a first plate 221 extending from the second clamp 212 of the clamping member 21 in a direction parallel to the substrate 30 and connected electrically to the ground pattern 33 using surface mounting technologies, and a second plate portion 222 connected integrally to the first plate portion 221 and extending away from the coaxial cable 1 and through the through hole 35 in the substrate 30 of the planar antenna 3. Further, the second plate portion 222 has a free end 2221 bent so as to extend parallel to the second surface 32 of the substrate 30 of the planar antenna 3 and away from the clamping member 21, as shown in FIG. 3.

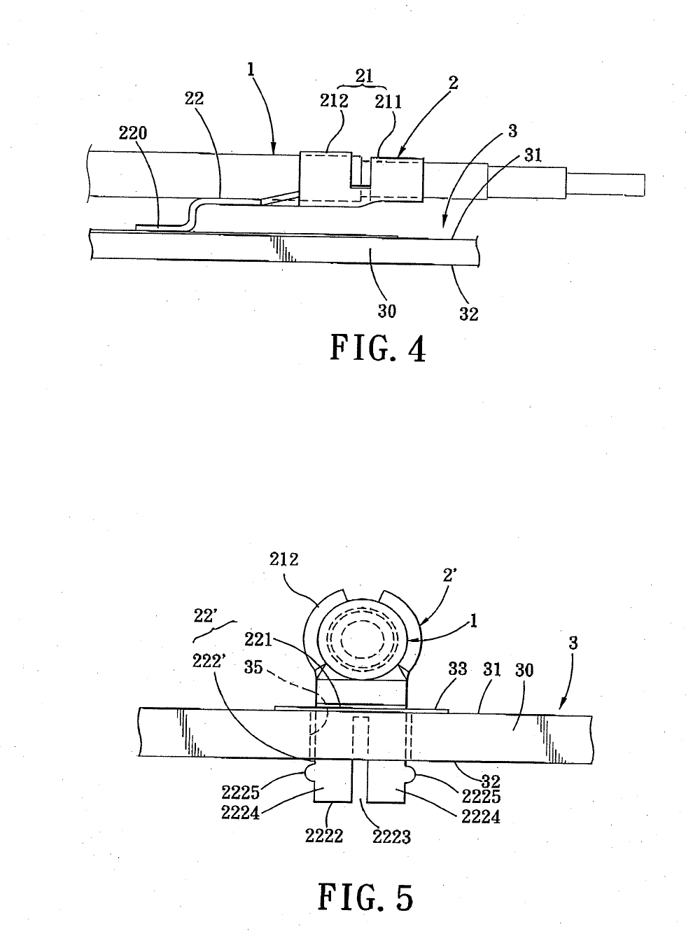

FIG. 4 illustrates an antenna device according to a second preferred embodiment of this invention, which is a modification of the first preferred embodiment. The second preferred embodiment differs from the first preferred embodiment in that there is no need to form a through hole in the substrate 30 of the planar antenna 3 and that the connecting member 2 is bent to have a free end portion 220 extending parallel to the first surface 31 of the substrate 30 of the planar antenna 3 and connected electrically to the ground pattern 33 using surface mounting technologies.

FIG. 5 illustrates an antenna device according to a third preferred embodiment of this invention, which is a modification of the first preferred embodiment. In this embodiment, the second plate portion 222′ of the connecting member 22′ of the retainer 2′ has a bifurcated free end 2222 formed with a slot 2223 that extends toward the first plate portion 221 such that the second portion 222′ is divided into two leg parts 2224 by the slot 2223. The second plate portion 222′ is formed with opposite protrusions 2225 extending outwardly and respectively from the leg parts 2224 away from each other and disposed outwardly of the through hole 35 in the substrate 30. The protrusions 2225 are movable to contact the second surface 32 of the substrate 30 so as to prevent removal of the second plate portion 222′ from the substrate 30.

In sum, since the connecting member 22, 22′ of the retainer 2, 2′ is connected electrically and directly to the ground pattern 33 of the substrate 30 of the planar antenna 3, damage to the insulator 13 of the coaxial cable 1 can be avoided. Furthermore, due to the presence of the clamping member 21 of the retainer 2, 2′, the coaxial cable 1 can be effectively positioned when assembled to the substrate 30.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A retainer for retaining a coaxial cable on a planar antenna, the coaxial cable including a core conductor disposed at the center thereof, an insulator provided around the core conductor, an outer conductor provided around the insulator, and an insulating sheath provided around the outer conductor, said retainer being metallic and comprising:
a clamping member including a first C-shaped clamp adapted for clamping the outer conductor of the coaxial cable such that said first clamp is adapted to contact electrically the outer conductor of the coaxial cable; and
a connecting member connected integrally to said clamping member and adapted to be connected electrically to the planar antenna.

2. The retainer as claimed in claim 1, wherein said clamping member further includes a second C-shaped clamp adapted to clamp the insulating sheath.

3. The retainer as claimed in claim 1, wherein said connecting member is in the form of an inverted L-shaped plate that has a first plate portion extending from said clamping member in a direction parallel to the planar antenna, and a second plate portion connected integrally to said first plate portion and extending away from the coaxial cable.

4. The retainer as claimed in claim 3, wherein said second plate portion of said connecting member has a free end bent so as to extend parallel to said first plate portion and away from said clamping member.

5. The retainer as claimed in claim 3, wherein said second plate portion of said connecting member has a bifurcated free end formed with a slot that extends toward said first plate portion such that said second plate portion is divided into two leg parts by said slot, said second plate portion being formed with opposite protrusions extending outwardly and respectively from said leg parts away from each other

6. An antenna device comprising:
a planar antenna including
a substrate having a first surface provided with a ground pattern and a conductor pattern thereon, and a second surface opposite to said first surface;
a coaxial cable including a core conductor disposed at the center thereof, an insulator provided around said core conductor, an outer conductor provided around said insulator, and an insulating sheath provided around said outer conductor; and
a retainer made of a metal material and including
a clamping member including a C-shaped first clamp for clamping said outer conductor of said coaxial cable such that said first clamp contacts electrically said outer conductor of said coaxial cable, and
a connecting member connected integrally to said clamping member and connected electrically to said ground pattern of said substrate of said planar antenna.

7. The antenna device as claimed in claim 6, wherein said clamping member further includes a C-shaped second clamp for clamping said insulating sheath.

8. The antenna device as claimed in claim 6, wherein:
said substrate of said planar antenna is formed with a through hole extending from said first surface to said second surface; and
said connecting member of said retainer is in the form of an inverted L-shaped plate that has a first plate portion extending from said clamping member in a direction parallel to said substrate and connected electrically to said ground pattern of said substrate of said planar antenna, and a second plate portion connected integrally to said first plate portion and extending away from said coaxial cable and through said through hole in said substrate of said planar antenna.

9. The antenna device as claimed in claim 8, wherein said second plate portion of said connecting member has a free end bent so as to extend parallel to said second surface of said substrate of said planar antenna and away from said clamping member.

10. The antenna device as claimed in claim 8, wherein said second plate portion of said connecting member of said retainer has a bifurcated free end formed with a slot that extends toward said first plate portion such that said second plate portion is divided into two leg parts by said slot, said second plate portion being formed with opposite protrusions extending outwardly and respectively from said leg parts away from each other and disposed outwardly of said through hole in said substrate, said protrusions being movable to contact said second surface of said substrate so as to prevent removal of said second plate portion from said substrate.
